(19) United States
(12) Patent Application Publication
(10) Pub. No.: US 2025/0012574 A1
(43) Pub. Date: Jan. 9, 2025

(54) CHARGING FACILITY DETERMINATION DEVICE, CHARGING FACILITY DETERMINATION METHOD, AND RECORDING MEDIUM

(71) Applicant: NEC Corporation, Minato-ku, Tokyo (JP)

(72) Inventors: Remi TANAKA, Tokyo (JP); Takeshi Shouta, Tokyo (JP); Hiroyuki Kakinuma, Tokyo (JP); Tomoyuki Muto, Tokyo (JP); Toshihide Yoshimura, Tokyo (JP)

(73) Assignee: NEC Corporation, Minato-ku, Tokyo (JP)

(21) Appl. No.: 18/713,315

(22) PCT Filed: Dec. 23, 2021
(86) PCT No.: PCT/JP2021/047882

§ 371 Date: May 24, 2024

(51) Int. Cl. G01C 21/20

(52) U.S. Cl. CPC G01C 21/20

(57) ABSTRACT

In the present invention, to make it possible to reduce the wait time for charging an unmanned aerial vehicle at a charging facility, information that can be used to determine the cruising range of an unmanned aerial vehicle is acquired, a priority on the use of a charging facility by an unmanned aerial vehicle is set according to intended use, and a charging facility to be used by an unmanned aerial vehicle is determined on the basis of the priority and the cruising range calculated on the basis of the information that can be used to determine the cruising range.

### TECHNICAL FIELD

The present invention relates to a charging facility determination device, a charging facility determination method, and a recording medium.

### BACKGROUND ART

In recent years, there has been an increasing demand for the operation of drones that fly in the air in an unmanned manner.

PTL 1 describes that a drone port disposed at an appropriate position of a flight route to park a drone has a charging function. PTL 1 describes that a drone port system charges a battery of a drone at a drone port and causes the drone to fly to another drone port or a distribution center.

PTL 2 describes that when it can be determined that a travelable distance is equal to or less than a distance of the entire path with respect to a distance of a set planned path, the navigation device searches for a charging stand present within the travelable distance and resets the path.

### CITATION LIST

### Patent Literature

PTL 1: JP 2019-89461 A
PTL 2: WO 2021/038940 A1

### SUMMARY OF INVENTION

### Technical Problem

In the methods described in PTLs 1 and 2, in a case where another unmanned flying object has already used the charging facility, the unmanned flying object is required to wait until the charging of the another unmanned flying object is completed. As described above, in the methods described in PTLs 1 to 2, there is a problem that the unmanned flying object waits for charging.

In view of the above-described problems, an object of the present invention is to provide a charging facility determination device, a charging facility determination method, and a recording medium capable of reducing waiting for charging in a charging facility of an unmanned flying object.

### Solution to Problem

In an aspect of the present invention, a charging facility determination device includes an acquisition means configured to acquire information capable of grasping a cruisable range of an unmanned flying object, a setting means configured to set priority with which the unmanned flying object uses a charging facility according to a use, and a determination means configured to determine a charging facility to be used by the unmanned flying object based on the cruisable range and the priority, the cruisable range being calculated by a calculation means based on the information.

In another aspect of the present invention, a charging facility determination method includes acquiring information capable of grasping a cruisable range of an unmanned flying object, setting priority with which the unmanned flying object uses a charging facility according to a use, and determining a charging facility to be used by the unmanned flying object based on the cruisable range and the priority, the cruisable range being calculated based on the information.

In another aspect of the present invention, a charging facility determination program recorded in a computer-readable recording medium causes a computer to implement an acquisition function of acquiring information capable of grasping a cruisable range of an unmanned flying object, a setting function of setting priority with which the unmanned flying object uses a charging facility according to a use, and a determination function of determining a charging facility to be used by the unmanned flying object based on the cruisable range and the priority, the cruisable range being calculated by a calculation means based on the information.

### Advantageous Effects of Invention

With the charging facility determination device, the charging facility determination method, and the recording medium of the present invention, it is possible to reduce waiting for charging in the charging facility of the unmanned flying object.

### BRIEF DESCRIPTION OF DRAWINGS

FIG. 1 is a block diagram illustrating a configuration example of a charging facility determination device according to the first example embodiment of the present invention.

FIG. 2 is a flowchart illustrating an operation example of the charging facility determination device according to the first example embodiment of the present invention.

FIG. 3 is a block diagram illustrating a configuration example of a charging facility determination system according to the second example embodiment of the present invention.

FIG. 4 is a diagram illustrating an example of charging facility management information stored in a facility information storage unit of a charging facility determination device according to the second example embodiment of the present invention.

FIG. 5 is a sequence diagram illustrating an operation example of a charging facility determination system according to the second example embodiment of the present invention.

FIG. 6 is a flowchart illustrating an operation example of a charging facility determination device according to the second example embodiment of the present invention.

FIG. 7 is a diagram illustrating a hardware configuration example of each example embodiment in the present invention.

### EXAMPLE EMBODIMENT

### First Example Embodiment

The first example embodiment of the present invention will be described.

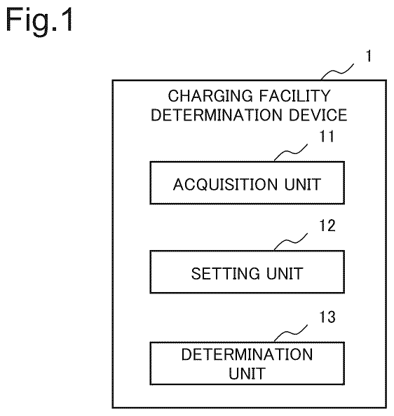

FIG. 1 is a block diagram illustrating a configuration example of a charging facility determination device 1 of the present example embodiment.

The charging facility determination device 1 of the present example embodiment includes an acquisition unit 11, a setting unit 12, and a determination unit 13.

The acquisition unit 11 is an example of an acquisition means. The acquisition unit 11 acquires information capable of grasping a cruisable range of an unmanned flying object (not illustrated). For example, the acquisition unit 11 acquires information capable of grasping the cruisable range from a control device (not illustrated) that an operator who operates an unmanned flying object uses for controlling the unmanned flying object. The acquisition unit 11 may acquire information capable of grasping the cruisable range from a database provided in the control device. The unmanned flying object is, for example, a drone. Alternatively, the unmanned flying object is, for example, an electric vertical take-off and landing (eVTOL). The eVTOL is also referred to as an electric vertical takeoff and landing machine. The “unmanned flying object” refers to a flying object that flies by remote control or automatic control. The unmanned flying object may carry and transport passengers.

The information capable of grasping the cruisable range is, for example, information indicating the cruisable range itself. For example, the information indicating the cruisable range itself is information indicating a range that can be cruised from the current position of the unmanned flying object. Alternatively, for example, the information capable of grasping the cruisable range is information indicating a distance that the unmanned flying object can fly from the current position.

The information capable of grasping the cruisable range may be information used for processing of calculating the cruisable range. For example, the information capable of grasping the cruisable range is at least one or more pieces of information of the following (1) to (6).
(1) Information indicating the current position of the unmanned flying object
(2) Information indicating the current storage amount of the unmanned flying object
(3) Information indicating the flight capability of the unmanned flying object
(4) Information indicating the weight of the cargo carried by the unmanned flying object
(5) Information indicating the wind direction at the current position of the unmanned flying object
(6) Information indicating the wind speed at the current position of the unmanned flying object

A calculation unit (not illustrated) of the charging facility determination device 1 or a calculation unit (not illustrated) of the control device calculates a cruisable range from information capable of grasping the cruisable range. The calculation unit is an example of a calculation means. For example, in the process of calculating the cruisable range, the calculation unit uses a value indicated in any one or more pieces of information of (1) to (6) as a calculation parameter. That is, the calculation unit calculates the cruisable range by using a value indicated in any one or more pieces of information of (1) to (6) as a variable of a function of calculating the cruisable range.

The information indicating the flight capability of the unmanned flying object is, for example, information indicating a flyable time and a flyable distance of the unmanned flying object. The flyable time may be a flyable time according to the unit storage amount, or may be a flyable time at the time of the maximum storage amount. The flyable distance may be a flyable distance according to the unit storage amount, or may be a flyable distance at the time of the maximum storage amount.

The setting unit 12 is an example of a setting means. The setting unit 12 sets the priority with which the unmanned flying object uses the charging facility according to the use.

For example, the setting unit 12 sets a higher priority to the unmanned flying object used in the emergency situation and sets a lower priority to the unmanned flying object used in the normal time. For example, the setting unit 12 sets a higher priority to an unmanned flying object used for spraying a fire extinguishing agent above a place where a forest fire has occurred than to an unmanned flying object carrying a normal cargo.

The determination unit 13 is an example of a determination means. The determination unit 13 determines the charging facility to be used by the unmanned flying object based on the cruisable range calculated by the calculation unit based on the information capable of grasping the cruisable range and the priority.

As described above, the charging facility determination device 1 acquires information capable of grasping the cruisable range of the unmanned flying object, and sets the priority with which the unmanned flying object uses the charging facility according to the use. The charging facility determination device 1 determines the charging facility to be used by the unmanned flying object based on the cruisable range calculated by the calculation unit based on the information capable of grasping the cruisable range and the priority. The charging facility determination device 1 determines the charging facility to be used by the unmanned flying object based on the cruisable range and the priority, so that the determined charging facility can be used by the unmanned flying object. This makes it possible to reduce waiting for charging in the charging facility of the unmanned flying object.

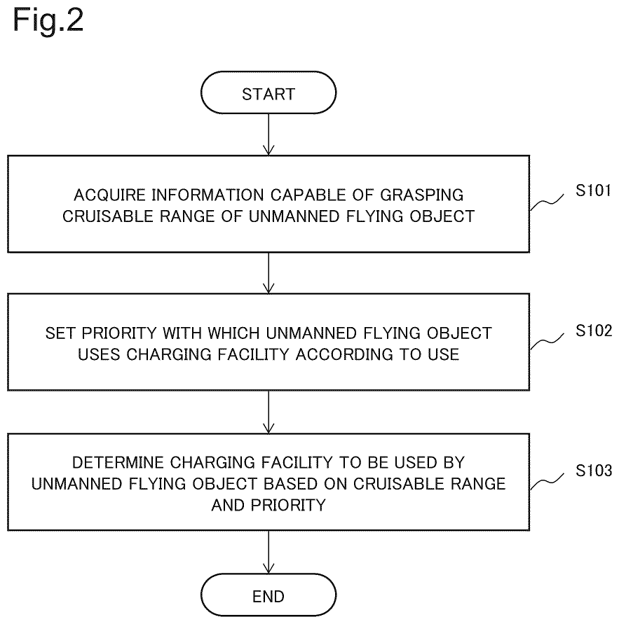

Next, an operation example of the charging facility determination device 1 of the present example embodiment will be described with reference to FIG. 2. FIG. 2 is a flowchart illustrating an operation example of the charging facility determination device 1.

The acquisition unit 11 acquires information capable of grasping the cruisable range of the unmanned flying object (step S101).

The setting unit 12 sets the priority with which the unmanned flying object uses the charging facility according to the use (step S102).

The determination unit 13 determines a charging facility to be used by the unmanned flying object based on the cruisable range and the priority (step S103). The calculation unit calculates the cruisable range of the unmanned flying object based on the information capable of grasping the cruisable range, the information being acquired by the acquisition unit 11.

As described above, the charging facility determination device 1 determines the charging facility to be used by the unmanned flying object based on the cruisable range and the priority, whereby the determined charging facility can be used by the unmanned flying object. This makes it possible to reduce waiting for charging in the charging facility of the unmanned flying object.

### Second Example Embodiment

Next, a charging facility determination device 4 according to the second example embodiment of the present invention will be specifically described.

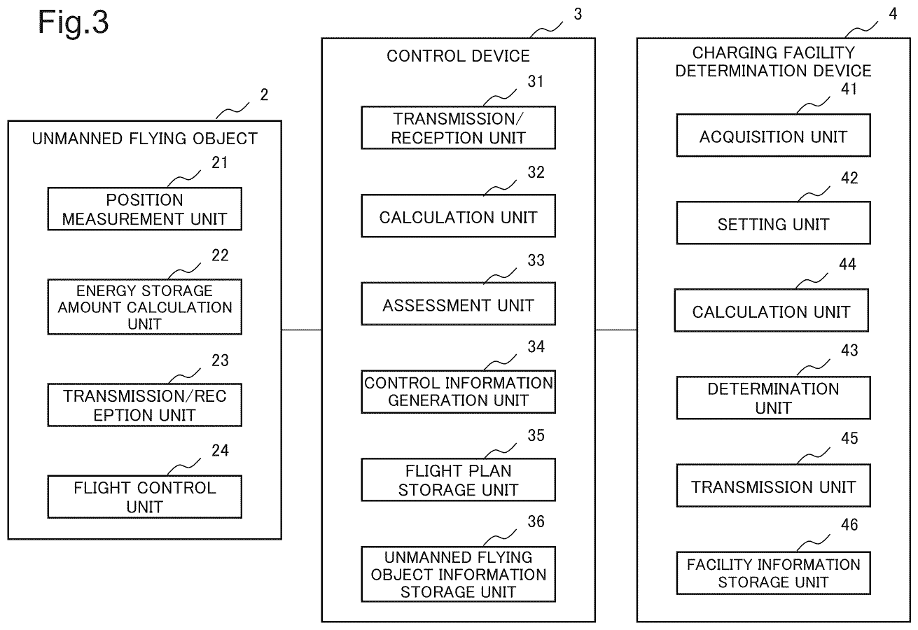

FIG. 3 is a block diagram illustrating a configuration example of a charging facility determination system according to the second example embodiment of the present invention.

As illustrated in FIG. 3, the charging facility determination system includes an unmanned flying object 2, a control device 3, and the charging facility determination device 4. In the second example embodiment, the charging facility determination device 4 basically includes a configuration and a function of the charging facility determination device 1 of the first example embodiment.

The configuration of the unmanned flying object 2 of the present example embodiment will be described in detail with reference to FIG. 3. The unmanned flying object 2 includes a position measurement unit 21, a storage amount calculation unit 22, a transmission/reception unit 23, and a flight control unit 24.

The position measurement unit 21 measures the position of the unmanned flying object 2. For example, the position measurement unit 21 performs positioning by receiving a signal from a satellite in a global positioning system (GPS). The position measurement unit 21 may be configured to perform position measurement by receiving a signal from a satellite or the like in another global navigation satellite system (GNSS) instead of the GPS.

The storage amount calculation unit 22 calculates a current storage amount of a battery (not illustrated) of the unmanned flying object 2. For example, the storage amount calculation unit 22 calculates the storage amount by a voltage measurement method of measuring the terminal voltage of the battery and calculating the current storage amount. In addition to this method, any method can be used as a method of calculating the storage amount.

The transmission/reception unit 23 transmits the unmanned flying object identification information of the unmanned flying object 2, the position information, and the storage amount information in association with each other to the control device 3. The unmanned flying object identification information is information that can identify each unmanned flying object.

Alternatively, the transmission/reception unit 23 may transmit the remote identification (remote ID) and the storage amount information in association with each other to the control device 3. The remote ID is information included in a signal transmitted from the unmanned flying object 2 to the control device 3 during flight. The remote ID includes unmanned flying object identification information of the unmanned flying object 2, information capable of identifying the owner of the unmanned flying object 2, position information of the unmanned flying object 2, and the like.

The transmission/reception unit 23 receives the flight control information from the control device 3.

The flight control unit 24 controls the unmanned flying object 2 based on the flight control information. Specifically, the flight control unit 24 controls the rotation of a propeller (not illustrated) of the unmanned flying object 2 based on the flight control information, thereby controlling the moving direction and the attitude of the unmanned flying object 2.

Under the control of the flight control unit 24, the unmanned flying object 2 heads for the charging facility determined by the charging facility determination device 4. The unmanned flying object 2 heading for the charging facility determined by the charging facility determination device 4 lands on the charging stand of the charging facility. The unmanned flying object 2 that has landed on the charging stand has a battery charged by wireless power supply.

The battery of the unmanned flying object 2 may be charged by wired power supply. In a case where the battery of the unmanned flying object 2 is charged by wired power supply, the charging stand of the charging facility is provided with a socket of the charging plug and a connection device. The connection device automatically inserts and removes the charging plug of the unmanned flying object 2 into and from the socket. For example, after the unmanned flying object 2 lands on the charging stand, the unmanned flying object 2 unwinds the charging cable including the charging plug in the direction of the socket. The connection device of the charging stand inserts the charging plug of the fed charging cable of the unmanned flying object 2 into the socket. When the charging of the battery of the unmanned flying object 2 is completed, the connection device removes the charging plug of the charging cable of the unmanned flying object 2 from the socket.

A configuration of the control device 3 of the present example embodiment will be described in detail with reference to FIG. 3. The control device 3 includes a transmission/reception unit 31, a calculation unit 32, an assessment unit 33, a control information generation unit 34, a flight plan storage unit 35, and an unmanned flying object information storage unit 36.

The control device 3 controls the unmanned flying object 2. The control device 3 controls one or more unmanned flying objects. For example, the control device 3 is used by a delivery company that provides a cargo transport service using an unmanned flying object, a government office or a local government that responds to a disaster using an unmanned flying object, an organization that operates other unmanned flying objects, or the like. The control device 3 can be installed at any place. For example, the control device 3 is installed in a server room of a delivery company, a government office, a local government, an organization that operates an unmanned flying object, or the like.

The control device 3 acquires unmanned flying object identification information of the unmanned flying object 2, position information, and storage amount information. The control device 3 generates information capable of grasping the cruisable range of the unmanned flying object 2. The control device 3 transmits unmanned flying object identification information of the unmanned flying object 2, information capable of grasping the cruisable range, and flight plan information to the charging facility determination device 4. The control device 3 receives, from the charging facility determination device 4, facility position information and time zone information of the charging facility determined by the charging facility determination device 4 based on the transmitted information. The time zone information will be described later. The control device 3 generates flight control information for causing the unmanned flying object 2 to fly in such a way as to arrive at a position indicated by the facility position information. The control device 3 controls the unmanned flying object 2 by transmitting the flight control information to the unmanned flying object 2.

First, the operation of each configuration of the control device 3 of the present example embodiment will be described in detail for a case where information capable of grasping the cruisable range is transmitted to the charging facility determination device 4.

The transmission/reception unit 31 receives the unmanned flying object identification information, the position information, and the storage amount information from the unmanned flying object (in the present example, the unmanned flying object 2). The transmission/reception unit 31 outputs the received unmanned flying object identification information of the unmanned flying object 2, the received position information, and the received storage amount information in association with each other to the calculation unit 32.

In a case where the transmission/reception unit 31 receives the remote ID and the storage amount information, the transmission/reception unit 31 performs the following operation. The transmission/reception unit 31 outputs the storage amount information, the unmanned flying object identification information of the unmanned flying object 2 included in the remote ID, and the position information of the unmanned flying object 2 in association with each other to the calculation unit 32.

The calculation unit 32 reads the flight plan information stored in the flight plan storage unit 35 in association with the unmanned flying object identification information of the unmanned flying object 2.

The flight plan storage unit 35 stores flight plan information of the unmanned flying object in advance. The flight plan information may be stored in the flight plan storage unit 35 according to an operation input into an input/output interface (not illustrated) by the user. Alternatively, the acquisition unit (not illustrated) of the control device 3 may acquire the flight plan information from an external server in which the flight plan information is stored or updated at a predetermined frequency. The acquisition unit may store the flight plan information in the flight plan storage unit 35 each time the flight plan information is acquired.

The flight plan information indicates a flight plan of the unmanned flying object (in the present example, the unmanned flying object 2). Specifically, the flight plan information includes unmanned flying object identification information of the unmanned flying object, flight plan identification information, use information, weight information, work start date and time information, departure place information, departure date and time information, destination information, arrival date and time information, and flight path information. The flight plan identification information is information for identifying a flight plan. The use information indicates a use of the unmanned flying object. The weight information indicates a weight of the cargo carried by the unmanned flying object. The work start date and time information indicates a date and time when the unmanned flying object starts work according to the use. The departure place information indicates a departure place of the unmanned flying object. The departure date and time information indicates a departure date and time of the unmanned flying object. The destination information indicates a destination of the unmanned flying object. The arrival date and time information indicates an arrival date and time of the unmanned flying object at the destination. The flight path information indicates a flight path.

The calculation unit 32 reads the flight capability information stored in the unmanned flying object information storage unit 36 in association with the unmanned flying object identification information of the unmanned flying object 2.

The unmanned flying object information storage unit 36 stores flight capability information that is information indicating the flight capability of the unmanned flying object. For example, the flight capability information is information indicating a flyable time and a flyable distance of the unmanned flying object.

The calculation unit 32 generates information capable of grasping the cruisable range based on the storage amount information of the unmanned flying object 2, the weight information of the flight plan information read from the flight plan storage unit 35, and the flight capability information read from the unmanned flying object information storage unit 36. In the present example embodiment, the information capable of grasping the cruisable range includes information indicating a cruisable distance and position information of the unmanned flying object 2.

The assessment unit 33 assesses whether the unmanned flying object (in the present example, the unmanned flying object 2) is required to use the charging facility. In a case where the assessment unit 33 assesses that the unmanned flying object 2 is required to use the charging facility, the assessment unit outputs the unmanned flying object identification information of the unmanned flying object 2, the information capable of grasping the cruisable range, and the flight plan information in association with each other to the transmission/reception unit 31. A specific assessment operation of the assessment unit 33 will be described in the description of the operation.

The transmission/reception unit 31 receives unmanned flying object identification information of the unmanned flying object 2, information capable of grasping the cruisable range, and flight plan information from the assessment unit 33. The transmission/reception unit 31 transmits the unmanned flying object identification information of the unmanned flying object 2, the information capable of grasping the cruisable range, and the flight plan information in association with one another to the charging facility determination device 4.

Next, the operation of each configuration of the control device 3 of the present example embodiment will be described in detail in a case where flight control information is transmitted to the unmanned flying object 2.

The transmission/reception unit 31 receives the unmanned flying object identification information of the unmanned flying object 2, the facility position information of the charging facility determined by the charging facility determination device 4, and the time zone information from the charging facility determination device 4. The time zone information includes start date and time information indicating the date and time when the unmanned flying object 2 starts the use of the charging facility and end date and time information indicating the date and time when the unmanned flying object 2 ends the use of the charging facility.

The control information generation unit 34 generates flight control information for causing the unmanned flying object 2 to fly in such a way that the unmanned flying object 2 arrives at the position indicated by the facility position information at the date and time indicated by the start date and time information of the time zone information. For example, the control information generation unit 34 generates flight control information for causing the unmanned flying object 2 to fly in such a way that the unmanned flying object 2 lands on the charging stand of the charging facility indicated by the facility position information. That is, the position indicated by the facility position information may be a position of the charging stand.

The control information generation unit 34 may generate the flight plan information of the flight path from the departure place to the current position, from the current position to the charging facility at the position indicated by the facility position information, and from the charging facility at the position indicated by the facility position information to the destination. For example, the flight path of the flight plan information generated by the control information generation unit 34 includes a flight path in which the flying object arrives at the charging facility at the position indicated by the facility position information from the current position at the date and time indicated by the start date and time information of the time zone information. For example, the flight path of the flight plan information generated by the control information generation unit 34 includes a flight path in which the flying object departs from the charging facility at the date and time indicated in the end date and time information of the time zone information and arrives at the destination. The control information generation unit 34 may replace the flight plan information of the unmanned flying object 2 stored in the flight plan storage unit 35 with the generated flight plan information.

The transmission/reception unit 31 transmits the flight control information to the unmanned flying object 2.

A configuration of the charging facility determination device 4 of the present example embodiment will be described in detail with reference to FIG. 3. The charging facility determination device 4 includes an acquisition unit 41, a setting unit 42, and a determination unit 43. The determination unit 43 receives an input from at least a calculation unit 44. A transmission unit 45 receives at least an input from the determination unit 43. A facility information storage unit 46 will be described later.

The charging facility determination device 4 determines a charging facility to be used by an unmanned flying object (in the present example, the unmanned flying object 2). For example, the charging facility determination device 4 is used by a manager who manages the charging facility. The charging facility determination device 4 may have the function of the control device 3. In a case where the charging facility determination device 4 has the function of the control device 3, the information capable of grasping the cruisable range of the unmanned flying object 2, the information being acquired by the acquisition unit 41, is, for example, position information and storage amount information transmitted from the unmanned flying object 2. The acquisition unit 41, the setting unit 42, and the determination unit 43 of the charging facility determination device 4 execute a process on at least one unmanned flying object. The acquisition unit 41, the setting unit 42, and the determination unit 43 of the charging facility determination device 4 may execute a process on two or more unmanned flying objects. The charging facility determination device 4 can be installed at any place. For example, the charging facility determination device 4 is installed in a server room of a manager who manages the charging facility.

In the present example embodiment, a case where the charging facility determination device 4 determines a charging facility to be used by the unmanned flying object 2 during flying will be described as an example. Alternatively, the charging facility determination device 4 may be used in a case where an operator of the unmanned flying object 2 creates a flight plan.

In the present example embodiment, a case where one or more charging facilities are provided in the charging area provided with the charging facility will be described as an example. The charging area is provided, for example, along a corridor which is an airspace in which a flying object including an unmanned flying object can fly in a specific direction. The charging area can be provided at an any position. In the charging area, an inspection service or a repair service of the unmanned flying object may be provided. For example, a camera for imaging the unmanned flying object may be provided in the charging area, and the inspector may check the appearance by viewing the image of the unmanned flying object from a remote place. Alternatively, an X-ray camera for imaging the unmanned flying object may be provided in the charging area, and the inspector may check the image by the X-ray camera. For example, the inspector inspects the soundness of the internal structure of the unmanned flying object imaged by the X-ray camera.

The acquisition unit 41 acquires information capable of grasping the cruisable range of the unmanned flying object 2. In the present example embodiment, the acquisition unit 41 receives the unmanned flying object identification information of the unmanned flying object 2, the information capable of grasping the cruisable range, and the flight plan information from the control device 3, thereby acquiring the information capable of grasping the cruisable range of the unmanned flying object 2.

The setting unit 42 sets the priority with which the unmanned flying object 2 uses the charging facility according to the use. The setting of the priority will be specifically described.

The setting unit 42 sets priority based on a predetermined condition regarding the use of the unmanned flying object 2. Specifically, for example, the setting unit 42 checks whether the use indicated in the use information of the flight plan information satisfies a predetermined condition for the use in which the unmanned flying object is used for coping with the emergency situation. Alternatively, for example, for the setting unit 42, in a case where the unmanned flying object 2 is deployed in a fire station or a fire department, the setting unit 42 sets a higher priority to an unmanned flying object used for coping with an emergency situation than an unmanned flying object used for normal use.

The emergency situation is, for example, a forest fire. In a case where an unmanned flying object that sprays a fire extinguishing agent over a place where a forest fire has occurred heads for the place where the forest fire has occurred for the purpose of extinguishing the fire, the setting unit 42 sets a higher priority to an unmanned flying object used for extinguishing the forest fire than an unmanned flying object used for a normal purpose of carrying a cargo.

Alternatively, the emergency situation is an earthquake disaster. The setting unit 42 sets a higher priority to an unmanned flying object used for carrying relief supplies to a disaster-stricken area than to an unmanned flying object used for normal use.

That is, the setting unit 42 sets a higher priority (for example, “5”) to an unmanned flying object (that is, the unmanned flying object that meets the condition that the unmanned flying object is used in an emergency situation) used in the emergency situation. The setting unit 42 sets a lower priority (for example, “1”) to an unmanned flying object (that is, the unmanned flying object that does not meet the condition that the unmanned flying object is used in an emergency situation) used in a normal state.

The setting unit 42 sets the priority based on the condition regarding the work start date and time of the unmanned flying object 2. Specifically, the setting unit 42 sets a higher priority to an unmanned flying object whose work start date and time indicated in the work start date and time information of the flight plan information is closer to the current date and time than to an unmanned flying object whose work start date and time is farther from the current date and time.

The setting unit 42 may set the priority based on a condition that the unmanned flying object 2 to which the priority is set can preferentially use the charging facility. Specifically, the setting unit 42 may set a higher priority to the unmanned flying object 2 that can preferentially use the charging facility than to the unmanned flying object that cannot preferentially use the charging facility based on the information indicating whether the charging facility can be preferentially used. For example, it is assumed that the owner of the unmanned flying object 2 subscribes to a service in which the charging facility can be preferentially used. In a case where the owner subscribes to a service in which the charging facility can be preferentially used, information indicating that the charging facility can be preferentially used is included in the flight plan information of the unmanned flying object of the owner. In a case where the flight plan information includes information indicating that the charging facility can be preferentially used, the setting unit 42 assesses that a condition that the unmanned flying object 2 can preferentially use the charging facility is satisfied and the charging facility can be preferentially used. The setting unit 42 sets a higher priority to the unmanned flying object 2 that is assessed to be able to preferentially use the charging facility than to the unmanned flying object that cannot preferentially use the charging facility.

The setting unit 42 may set the priority based on a condition for the cargo carried by the unmanned flying object. For example, the flight plan information may include information indicating that a cargo carried by the unmanned flying object is delivered earlier than a normal cargo. For example, in a case where the flight plan information includes information indicating that the cargo carried by the unmanned flying object 2 is delivered earlier than the normal cargo, the setting unit 42 sets a higher priority to the unmanned flying object 2 that carries the cargo delivered earlier than the normal cargo than to the unmanned flying object that carries the normal cargo.

The setting unit 42 may set the priority based on a condition regarding a distance that the unmanned flying object will fly from now. For example, the setting unit 42 may set a higher priority to the unmanned flying object having a longer distance from the current position of the unmanned flying object to the destination. Alternatively, the setting unit 42 may set the priority based on a condition regarding the distance that the unmanned flying object can navigate. The setting unit 42 may set a priority higher to an unmanned flying object having a flyable distance equal to or more than a predetermined threshold value to an unmanned flying object having a flyable distance shorter than the predetermined threshold value based on the information capable of grasping the cruisable range. In a case where the flyable distance is shorter than a predetermined threshold value, it is assumed that the unmanned flying object may crash and has high urgency of charging.

The setting unit 42 may set the priority based on a condition regarding the current storage amount of the unmanned flying object. For example, the setting unit 42 may set a higher priority to the unmanned flying object whose current storage amount is smaller. For example, the setting unit 42 may be configured to set the priority set according to the use of the unmanned flying object to a higher priority (for example, priority higher by one stage) in a case where a condition that the current storage amount of the unmanned flying object is smaller than a predetermined value is satisfied.

The setting unit 42 may be configured to set different priorities according to the use of the plurality of unmanned flying objects and the like.

The setting unit 42 may use any one of the exemplified predetermined conditions, or may use two or more predetermined conditions. As the predetermined condition, the setting unit 42 ca use any condition other than the exemplified conditions. For example, in a case where a forest fire occurs at a plurality of places or in a case where a forest fire occurs in a wide area, it is assumed that a plurality of unmanned flying objects is used to extinguish the forest fire. It is assumed that the plurality of unmanned flying objects having the same priority of the conditions for the use includes unmanned flying objects having different work start dates and times, that is, different priorities for the work start dates and times.

In a case where two or more predetermined conditions are used, the setting unit 42 may set the priority under the first predetermined condition, and set the priority of a second predetermined condition used when the determination unit 43 cannot determine the charging facility with the priority of the first predetermined condition. For example, the second predetermined condition is a different type of condition from the first predetermined condition.

In a case where the charging facility cannot be determined based on the priority of the first predetermined condition, the determination unit 43 determines the charging facility of the unmanned flying object 2 for the priority of the second predetermined condition. For example, the setting unit 42 sets the priority of the predetermined condition for the use, and sets the priority of the predetermined condition for the work start date and time used when the charging facility cannot be determined.

Alternatively, in a case where two or more predetermined conditions are used, the setting unit 42 may calculate an addition priority obtained by adding the priority set for each predetermined condition. Alternatively, the setting unit 42 may calculate a weight priority that is a value obtained by weighting the priority set for each predetermined condition according to the degree of importance of each preset priority and aggregating the priorities.

In a case where the addition priority or the weight priority is calculated, the setting unit 42 outputs the addition priority or the weight priority instead of the priority to the determination unit 43. The determination unit 43 and the transmission unit 45 described later execute a process on the addition priority or the weight priority.

The calculation unit 44 calculates the cruisable range based on the information capable of grasping the cruisable range of the unmanned flying object 2, the information being acquired by the acquisition unit 41. Specifically, the calculation unit 44 calculates the cruisable range based on the information indicating the cruisable distance included in the information capable of grasping the cruisable range and the position information. For example, the calculation unit 44 calculates, as the cruisable range, a range that can be reached within a distance indicated by information indicating a cruisable distance from the current position of the unmanned flying object 2 indicated by the position information.

The determination unit 43 determines a charging facility to be used by the unmanned flying object 2 based on the cruisable range calculated by the calculation unit 44 and the priority.

The determination unit 43 reads the charging facility management information associated with the facility position information in the cruisable range from the facility information storage unit 46.

The charging facility management information includes the charging facility identification information, the charging area identification information, the facility position information, the usage condition information, the unmanned flying object identification information, the priority information, and the time zone information. The charging facility identification information is information capable of identifying each of the charging facilities. The charging area identification information is information that can identify each of the charging areas. The facility position information indicates a position of each of the charging facilities. The facility information storage unit 46 stores the unmanned flying object identification information of an unmanned flying object scheduled to use the charging facility or using the charging facility, the usage condition information, the priority information, and the time zone information in association with the charging facility identification information. The usage condition information indicates a usage condition of the charging facility. The priority information indicates the priority set to the unmanned flying object using the charging facility. The time zone information is information indicating a time zone in which the unmanned flying object uses the charging facility. The time zone information includes start date and time information indicating a date and time when the use of the charging facility is started and end date and time information indicating a date and time when the use of the charging facility is ended.

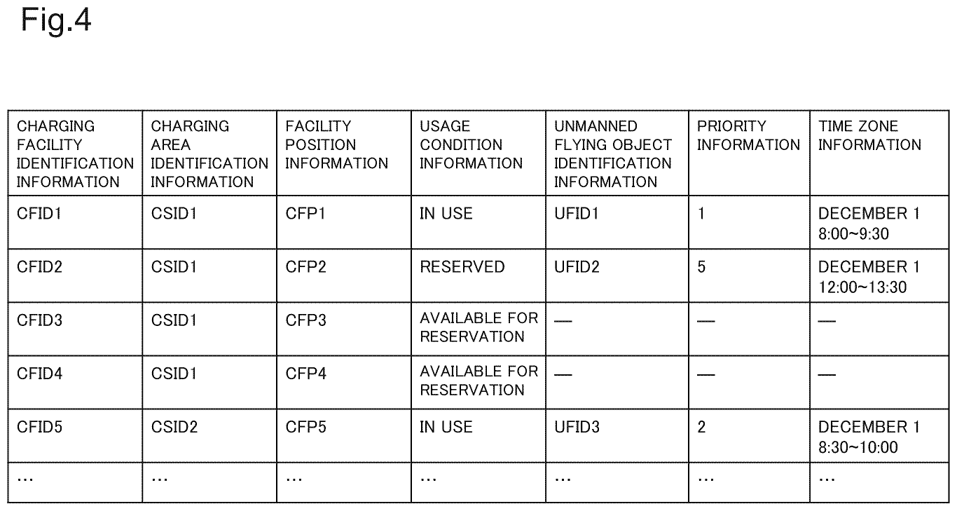

The facility information storage unit 46 stores charging facility management information. FIG. 4 is a diagram illustrating an example of the charging facility management information stored in the facility information storage unit 46 of the charging facility determination device 4. FIG. 4 illustrates an example of the charging facility management information for each of the charging facilities whose charging facility identification information is “CFID1”, “CFID2”, “CFID3”, “CFID4”, and “CFID5”.

The determination unit 43 identifies the charging facility based on the read charging facility management information. Specifically, the determination unit 43 identifies a charging facility indicating that the usage condition indicated by the usage condition information is usable and a charging facility used by another unmanned flying object associated with a priority lower than a priority indicated by the priority information set by the setting unit 42. the another unmanned flying object is an unmanned flying object other than the unmanned flying object 2.

For example, it is assumed that the charging facility management information illustrated in FIG. 4 is stored in the facility information storage unit 46, and the priority indicated in the priority information set by the setting unit 42 indicates “3”. It is assumed that the priority indicates that the unmanned flying object is to be prioritized as the value is larger. In this case, the determination unit 43 identifies, as the charging facility indicating that the usage condition is available, the charging facilities whose charging facility identification information indicating that the usage condition indicated in the usage condition information is “available for reservation” is “CFID3” and “CFID4”. The determination unit 43 identifies the charging facilities whose charging facility identification information used by the another unmanned flying object associated with a priority lower than a priority (in this example, “3”) indicated by the priority information set by the setting unit 42 is “CFID1” and “CFID5”. The “charging facility used by the another unmanned flying object” may be a charging facility (in the example of FIG. 4, the charging facility whose usage condition indicated by the usage condition information is “in use”) currently used by the another unmanned flying object. Alternatively, the “charging facility used by the another unmanned flying object” may be a charging facility (in the example of FIG. 4, the charging facility whose usage condition indicated by the usage condition information is “reserved”) to be used by the another unmanned flying object.

The determination unit 43 determines a charging facility to be used by the unmanned flying object 2 from the identified charging facilities. For example, the determination unit 43 determines a charging facility to be used by the unmanned flying object 2 by the following method. The determination unit 43 determines the charging facility on the planned flight path of the unmanned flying object 2 as the charging facility to be used by the unmanned flying object 2.

The determination unit 43 determines a time zone in which the unmanned flying object 2 uses the determined charging facility. For example, the determination unit 43 determines a time zone from the scheduled date and time to the date and time when the battery reaches the storage amount at which the unmanned flying object 2 can reach the destination, and generates time zone information indicating the determined time zone. The determination unit 43 may determine a time zone from the scheduled date and time until the battery of the unmanned flying object 2 is charged to the upper limit. The determination unit 43 updates the charging facility management information stored in the facility information storage unit 46 of the determined charging facility. For example, the determination unit 43 updates the usage condition information (“reserved”), the unmanned flying object identification information of the unmanned flying object 2, the priority information set by the setting unit 42, and the time zone information of the charging facility management information stored in the facility information storage unit 46.

When determining a time zone in which the unmanned flying object 2 uses the determined charging facility, the determination unit 43 may determine a time zone in which the unmanned flying object 2 is caused to stand by in the air above the charging facility. For example, in a case where the unmanned flying object 2 can be caused to stand by in the air above the charging facility until the another unmanned flying object finishes charging, the determination unit 43 determines a time zone in which the unmanned flying object 2 is caused to stand by in the air above the charging facility until the another unmanned flying object finishes charging. The information capable of grasping the cruisable range may include information indicating a time during which the unmanned flying object 2 can fly. The determination unit 43 may determine whether it is possible to cause the unmanned flying object 2 to stand by in the air above the charging facility until the another unmanned flying object finishes charging based on the information indicating the time during which the unmanned flying object 2 can fly. The determination unit 43 determines a time zone in which the unmanned flying object 2 uses the charging facility after the time zone in which the unmanned flying object 2 is caused to stand by. In a case where the unmanned flying object 2 cannot be caused to stand by in the air above the charging facility until the another unmanned flying object finishes charging, the determination unit 43 may determine another charging facility instead of the determined charging facility, or may exclude the another unmanned flying object from the determined charging facility. A case where the another unmanned flying object is excluded from the determined charging facility will be described in detail in a modification.

The transmission unit 45 transmits the unmanned flying object identification information of the unmanned flying object 2, the facility position information of the determined charging facility, and the time zone information in association with each other to the control device 3. In a case where the storage unit (not illustrated) of the control device 3 stores the facility position information and the charging facility identification information in association with each other, the determination unit 43 may cause the transmission unit 45 to transmit the charging facility identification information instead of the facility position information.

As described above, the charging facility determination device 4 acquires information capable of grasping the cruisable range of the unmanned flying object 2, and sets the priority with which the unmanned flying object 2 uses the charging facility according to the use. The charging facility determination device 4 determines the charging facility to be used by the unmanned flying object 2 based on the cruisable range calculated based on the information capable of grasping the cruisable range and the priority. The charging facility determination device 4 determines the charging facility to be used by the unmanned flying object 2 based on the cruisable range and the priority, so that the determined charging facility can be used by the unmanned flying object 2. This makes it possible to reduce waiting for charging in the charging facility of the unmanned flying object 2.

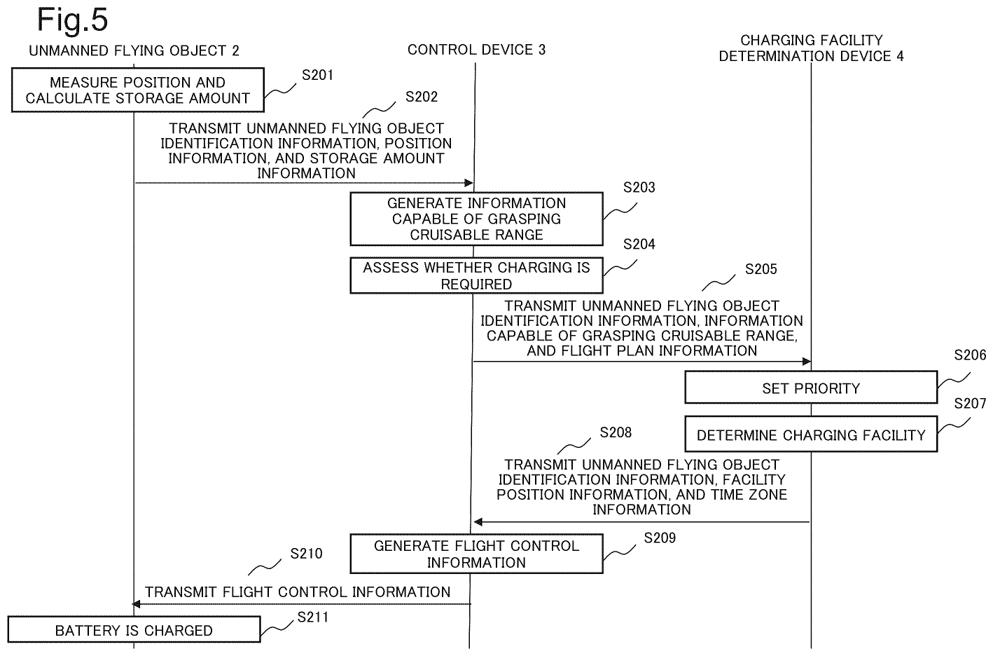

Next, an operation example of the charging facility determination system of the present example embodiment will be described with reference to FIG. 5. FIG. 5 is a sequence diagram illustrating an operation example of the charging facility determination system.

The position measurement unit 21 of the unmanned flying object 2 measures the position of the unmanned flying object 2. The position measurement unit 21 outputs position information indicating the measured position to the transmission/reception unit 23. The storage amount calculation unit 22 calculates the storage amount of the battery of the unmanned flying object 2 (step S201). The storage amount calculation unit 22 outputs storage amount information indicating the calculated storage amount to the transmission/reception unit 23. The position measurement unit 21 and the storage amount calculation unit 22 operate in an any order.

The position information is input to the transmission/reception unit 23 from the position measurement unit 21. The storage amount information is input from the storage amount calculation unit 22 to the transmission/reception unit 23. The transmission/reception unit 23 transmits the unmanned flying object identification information of the unmanned flying object 2, the position information, and the storage amount information to the control device 3 in association with each other (step S202).

The transmission/reception unit 31 of the control device 3 receives the unmanned flying object identification information of the unmanned flying object 2, the position information, and the storage amount information. The transmission/reception unit 31 outputs the received unmanned flying object identification information of the unmanned flying object 2, the received position information, and the received storage amount information in association with each other to the calculation unit 32.

The calculation unit 32 receives the unmanned flying object identification information of the unmanned flying object 2, the position information, and the storage amount information from the transmission/reception unit 31. The calculation unit 32 generates information capable of grasping the cruisable range of the unmanned flying object 2 having the storage amount indicated by the storage amount information (step S203). Specifically, the calculation unit 32 calculates a distance that the unmanned flying object 2 having the storage amount indicated by the storage amount information can navigate. The calculation unit 32 outputs the unmanned flying object identification information of the unmanned flying object 2 and the information capable of grasping the cruisable range of the unmanned flying object 2 in association with each other to the assessment unit 33. In the present example embodiment, the information capable of grasping the cruisable range includes information indicating a cruisable distance and position information of the unmanned flying object 2.

In step S203, for example, the calculation unit 32 calculates the distance that the unmanned flying object 2 can navigate as follows. For example, the calculation unit 32 calculates the distance that the unmanned flying object 2 can navigate based on the storage amount information of the unmanned flying object 2, the weight information of the flight plan information read from the flight plan storage unit 35, and the position information of the unmanned flying object 2. In addition to this method, any method can be used as a method of calculating the cruisable distance.

The position information, the unmanned flying object identification information of the unmanned flying object 2, and the information capable of grasping the cruisable range are input from the calculation unit 32 to the assessment unit 33. The assessment unit 33 reads the flight plan information stored in the flight plan storage unit 35 in association with the unmanned flying object identification information of the unmanned flying object 2. The assessment unit 33 calculates a scheduled flight distance that is a distance the unmanned flying object 2 flies from the current position of the unmanned flying object 2 indicated in the position information to the destination indicated in the destination information included in the flight plan information according to the flight path indicated in the flight path information.

The assessment unit 33 assesses whether the unmanned flying object 2 is required to use the charging facility (step S204). When assessing that the distance indicated by the information indicating the cruisable distance is longer than the scheduled flight distance, the assessment unit 33 assesses that the unmanned flying object 2 does not need to use the charging facility. When assessing that the distance indicated by the information indicating the cruisable distance is shorter than the scheduled flight distance, the assessment unit 33 assesses that the unmanned flying object 2 is required to use the charging facility. In a case where the assessment unit 33 assesses that the unmanned flying object 2 is required to use the charging facility, the assessment unit outputs the unmanned flying object identification information of the unmanned flying object 2, the information capable of grasping the cruisable range, and the flight plan information in association with each other to the transmission/reception unit 31. In a case where the assessment unit 33 assesses that the unmanned flying object 2 does not need to use the charging facility, the transmission/reception unit 31 does not perform the operation of step S205 described later.

The transmission/reception unit 31 transmits the unmanned flying object identification information of the unmanned flying object 2, the information capable of grasping the cruisable range, and the flight plan information in association with each other to the charging facility determination device 4 (step S205).

The acquisition unit 41 of the charging facility determination device 4 receives the unmanned flying object identification information of the unmanned flying object 2, the information capable of grasping the cruisable range, and the flight plan information from the control device 3, thereby acquiring the information capable of grasping the cruisable range of the unmanned flying object 2. The acquisition unit 41 outputs the unmanned flying object identification information of the unmanned flying object 2, the information capable of grasping the cruisable range, and the flight plan information in association with each other to the setting unit 42.

The setting unit 42 sets the priority with which the unmanned flying object 2 uses the charging facility according to the use (step S206). The setting unit 42 outputs the priority information indicating the set priority, the unmanned flying object identification information of the unmanned flying object 2, the information capable of grasping the cruisable range, and the flight plan information in association with one another to the calculation unit 44.

The calculation unit 44 receives, from the setting unit 42, priority information, unmanned flying object identification information of the unmanned flying object 2, information capable of grasping a cruisable range, and flight plan information. The calculation unit 44 calculates the cruisable range based on the information capable of grasping the cruisable range of the unmanned flying object 2, the information being acquired by the acquisition unit 41. The calculation unit 44 inputs information indicating the calculated cruisable range, priority information, unmanned flying object identification information of the unmanned flying object 2, and flight plan information to the determination unit 43.

The acquisition unit 41 of the charging facility determination device 4 may acquire information capable of grasping the cruisable range, the information including the position information of the unmanned flying object 2, the storage amount information of the unmanned flying object 2, and the flight capability information of the unmanned flying object 2. The calculation unit 44 of the charging facility determination device 4 may calculate the cruisable distance as in the operation of step S203 of the calculation unit 32 of the control device 3.

The information indicating a cruisable range, the priority information, the unmanned flying object identification information of the unmanned flying object 2, and the flight plan information are input from the calculation unit 44 to the determination unit 43. The determination unit 43 determines a charging facility to be used by the unmanned flying object 2 based on the cruisable range calculated by the calculation unit 44 and the priority (step S207). The determination unit 43 outputs the unmanned flying object identification information of the unmanned flying object 2, the facility position information of the determined charging facility, and the time zone information in association with each other to the transmission unit 45.

The transmission unit 45 transmits the unmanned flying object identification information of the unmanned flying object 2, the facility position information of the determined charging facility, and the time zone information in association with each other to the control device 3 (step S208).

The transmission/reception unit 31 of the control device 3 receives the unmanned flying object identification information of the unmanned flying object 2, the facility position information of the determined charging facility, and the time zone information from the charging facility determination device 4. The transmission/reception unit 31 outputs the unmanned flying object identification information of the unmanned flying object 2, the facility position information of the determined charging facility, and the time zone information in association with each other to the control information generation unit 34.

The control information generation unit 34 receives the unmanned flying object identification information of the unmanned flying object 2, the facility position information, and the time zone information from the transmission/reception unit 31. The control information generation unit 34 generates flight control information for causing the unmanned flying object 2 to fly in such a way as arrive at the position indicated by the facility position information at the date and time indicated by the start date and time information of the time zone information (step S209). The control information generation unit 34 outputs the unmanned flying object identification information of the unmanned flying object 2 and the generated flight control information in association with each other to the transmission/reception unit 31.

The transmission/reception unit 31 receives the unmanned flying object identification information of the unmanned flying object 2 and the flight control information from the control information generation unit 34. The transmission/reception unit 31 transmits the flight control information to the unmanned flying object 2 (step S210).

The transmission/reception unit 23 of the unmanned flying object 2 receives the flight control information from the control device 3. The transmission/reception unit 23 outputs the received flight control information to the flight control unit 24.

The flight control unit 24 receives flight control information from the transmission/reception unit 23. The flight control unit 24 controls the unmanned flying object 2 based on the flight control information. The unmanned flying object 2 heading for the charging facility determined by the charging facility determination device 4 lands on the charging stand of the charging facility. The unmanned flying object 2 that has landed on the charging stand is supplied with electric power from the charging stand, and the battery is charged (step S211).

Regardless of whether the unmanned flying object 2 is required to use the charging facility, the charging facility determination device 4 may determine the charging facility in a case where the determination of the charging facility is requested. For example, every time the unmanned flying object identification information, the position information, and the storage amount information are received from the unmanned flying object 2, the transmission/reception unit 31 of the control device 3 performs the operation of step S205. The assessment unit 33 does not perform the operation of step S204. The setting unit 42 of the charging facility determination device 4 performs the operation of step S206. The determination unit 43 determines at least one candidate for the charging facility to be used by the unmanned flying object 2 in step S207, and the transmission unit 45 transmits the facility position information of the charging facility and the time zone information determined in step S208 in association with each other to the control device 3. Upon receiving an operation input for selecting the charging facility by the user via an input/output interface (not illustrated) of the control device 3, the control device 3 requests the charging facility determination device 4 to permit use of the charging facility selected in accordance with the operation input by the user. The determination unit 43 of the charging facility determination device 4 updates the charging facility management information stored in the facility information storage unit 46 for the selected charging facility. The transmission unit 45 of the charging facility determination device 4 performs the operation of step S208 on the selected charging facility. The control device 3 performs the operations from step S209 to step S210. The unmanned flying object 2 performs the operation of step S211.

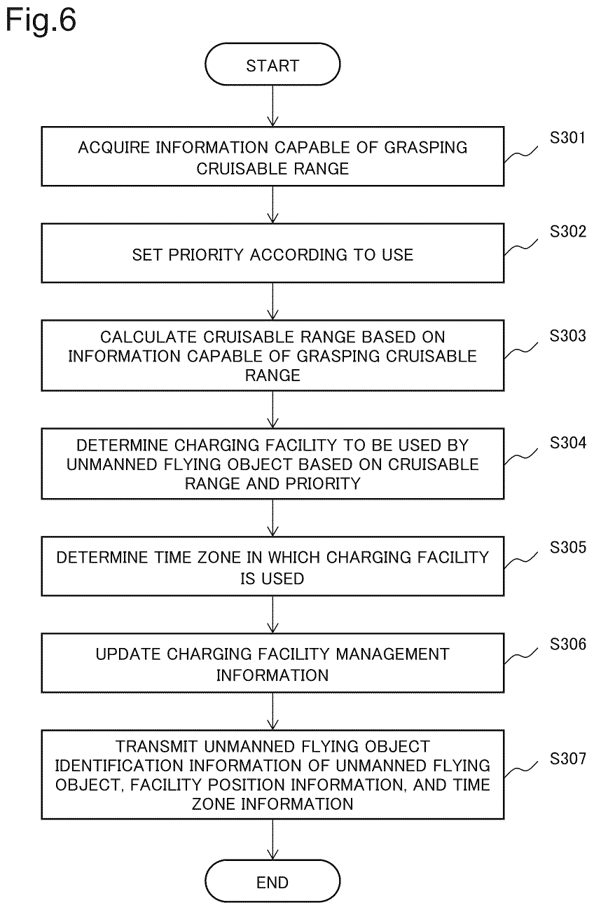

Next, the operation of the charging facility determination device 4 will be described with reference to FIG. 6. The operation of FIG. 6 details the operations of steps S206 to S208 of FIG. 5.

The acquisition unit 41 receives the unmanned flying object identification information of the unmanned flying object 2, the information capable of grasping the cruisable range, and the flight plan information from the control device 3, thereby acquiring the information capable of grasping the cruisable range of the unmanned flying object 2 (step S301).

The setting unit 42 sets the priority with which the unmanned flying object 2 uses the charging facility according to the use (step S302).

The calculation unit 44 calculates the cruisable range based on the information capable of grasping the cruisable range, the information being acquire by the acquisition unit 41 (step S303).

The determination unit 43 determines a charging facility to be used by the unmanned flying object 2 based on the cruisable range calculated by the calculation unit 44 and the priority (step S304).

The determination unit 43 determines a time zone in which the unmanned flying object 2 uses the determined charging facility (step S305). The determination unit 43 updates the charging facility management information stored in the facility information storage unit 46 for the determined charging facility (step S306).

The transmission unit 45 transmits the unmanned flying object identification information of the unmanned flying object 2, the facility position information of the determined charging facility, and the time zone information in association with each other to the control device 3 (step S307).

As described above, the charging facility determination device 4 according to the present example embodiment acquires information capable of grasping the cruisable range of the unmanned flying object 2, and sets the priority with which the unmanned flying object 2 uses the charging facility according to the use. The charging facility determination device 4 determines the charging facility to be used by the unmanned flying object 2 based on the cruisable range calculated based on the information capable of grasping the cruisable range and the priority. The charging facility determination device 4 determines the charging facility to be used by the unmanned flying object 2 based on the cruisable range and the priority, so that the determined charging facility can be used by the unmanned flying object 2. This makes it possible to reduce waiting for charging in the charging facility of the unmanned flying object.

The charging facility determination device 4 of the present example embodiment determines the charging facility to be used by the unmanned flying object according to the cruisable range and the priority. As a result, the charging facility determination device 4 can charge the battery of the unmanned flying object 2 according to the priority even in a case where the worker is evacuated from the charging area due to an earthquake or a forest fire and the worker cannot charge the battery of the unmanned flying object 2 or in a case of an unmanned charging area. It is possible to automatically supply power to one or more unmanned flying objects without human intervention.

The charging facility determination device 4 determines the charging facility each time information capable of grasping the cruisable range of the unmanned flying object is acquired from the control device 3 that has received the storage amount information transmitted from the unmanned flying object to be charged in association with the remote ID or the unmanned flying object identification information. As a result, the charging facility determination device 4 can manage the charging facility to be used by the unmanned flying object in real time according to the priority.

The charging facility determination device 4 of the present example embodiment sets the priority of the unmanned flying object 2 using two or more predetermined conditions. As a result, the charging facility determination device 4 of the present example embodiment can determine the charging facility of the unmanned flying object 2 based on the priority of another condition even in a case where the priorities of a certain predetermined condition among the predetermined conditions are equal.

The charging facility determination device 4 of the present example embodiment determines that the charging facility on the planned flight path of the unmanned flying object 2 among the usable charging facilities is used by the unmanned flying object 2. As a result, the charging facility determination device 4 can charge the battery of the unmanned flying object 2 with the charging facility on the path of the unmanned flying object 2.

### Modification of Second Example Embodiment

A charging facility determination device according to a modification of the second example embodiment is different from the charging facility determination device 4 according to the second example embodiment in that another unmanned flying object is excluded from the charging facility determined for the unmanned flying object 2.

The determination unit of the present modification determines a charging facility to be used by the another unmanned flying object associated with a priority lower than a priority indicated by the priority information set by the setting unit 42 as a charging facility to be used by the unmanned flying object 2.

The determination unit of the present modification predicts the storage amount to be charged in the battery of the another unmanned flying object at the scheduled date and time when the unmanned flying object 2 uses the charging facility. For example, the scheduled date and time is a date and time when the unmanned flying object 2 reaches the position indicated by the facility position information of the charging facility from the current position.

In a case where the determination unit predicts that the amount of power with which the another unmanned flying object can reach the destination is charged in the battery of the another unmanned flying object, the determination unit performs the following operation. The determination unit updates the charging facility management information of the another unmanned flying object in such a way that the another unmanned flying object uses the charging facility until the scheduled date and time. The determination unit requests the control device that controls the another unmanned flying object via the transmission unit 45 to control the another unmanned flying object in such a way as to cause the another unmanned flying object to head to the destination of the another unmanned flying object at the scheduled date and time. Specifically, the determination unit requests the control device of the another unmanned flying object to control the another unmanned flying object to head for the destination after charging at the charging facility determined for the unmanned flying object 2 until the scheduled date and time.

In a case where it is predicted that the amount of power with which the another unmanned flying object can reach the destination is not charged in the battery of the another unmanned flying object, the determination unit performs the following process. The determination unit determines a charging facility to be used by the another unmanned flying object, the charging facility being to be used next after the charging facility determined to be used by the unmanned flying object 2. The determination unit updates a charging facility management information of the charging facility to be used by the another unmanned flying object, a charging facility management information of the charging facility to be used next by the another unmanned flying object, and the charging facility management information of the charging facility related to the unmanned flying object 2. The determination unit requests a control device that controls the another unmanned flying object to control the another unmanned flying object via the transmission unit 45. Specifically, the determination unit requests the control device of the another unmanned flying object to control the another unmanned flying object to head for the charging facility determined to be used next after charging with the charging facility determined for the unmanned flying object 2 until the scheduled date and time.

Alternatively, in a case where the determination unit predicts that the amount of power with which the another unmanned flying object can reach the destination is not charged in the battery of the another unmanned flying object, the determination unit may perform the following process. The determination unit updates the charging facility management information of the another unmanned flying object in such a way that the another unmanned flying object uses the charging facility until the scheduled date and time. The determination unit assesses whether the another unmanned flying object can stand by in the air from the date and time indicated in the start date and time information of the unmanned flying object 2 to the date and time indicated in the end date and time information based on the charging time until the date and time indicated in the start date and time information. In a case where it is assessed that the another unmanned flying object can stand by, the determination unit requests the control device of the another unmanned flying object to charge the another unmanned flying object with the charging facility assessed for the unmanned flying object 2 until the scheduled date and time, and then cause the another unmanned flying object to stand by in the air until the date and time indicated by the end date and time information of the unmanned flying object 2. The determination unit requests the control device of the another unmanned flying object to cause the another unmanned flying object to use the charging facility again after the date and time indicated by the end date and time information of the unmanned flying object 2.

In a case where the determination unit predicts that the amount of power with which the another unmanned flying object can reach the destination is not charged in the battery of the another unmanned flying object, the determination unit may not determine the charging facility as a charging facility to be used by the unmanned flying object 2. The determination unit may determine the charging facility to be used by the unmanned flying object 2 from another usable charging facility and a charging facility to be used by the another unmanned flying object.

By performing the process in this manner, the charging facility determination device of the present modification can determine, as the charging facility to be used by the unmanned flying object 2, a charging facility that was scheduled to be used by the another unmanned flying object having a lower priority than the unmanned flying object 2. Since the charging facility determination device 4 requests the control device of the another unmanned flying object to perform control according to the storage amount at the scheduled date and time of the another unmanned flying object, it is possible to achieve both charging of the another unmanned flying object and charging of the unmanned flying object 2.

### <Hardware Configuration Example>

The procedure described in each of the above example embodiments can be implemented by a charging facility determination program for causing an information processing device (computer) functioning as a charging facility determination device to implement functions as these devices. The information processing device executes the charging facility determination method by the program. Hereinafter, a configuration example of a hardware resource that achieves each of the charging facility determination devices (1, 4) in the above-described example embodiments of the present invention using one information processing device (computer) will be described. The charging facility determination device may be achieved physically or functionally by using at least two information processing devices. The charging facility determination device may be achieved as a dedicated device. Only some of the functions of the charging facility determination device may be implemented using the information processing device.

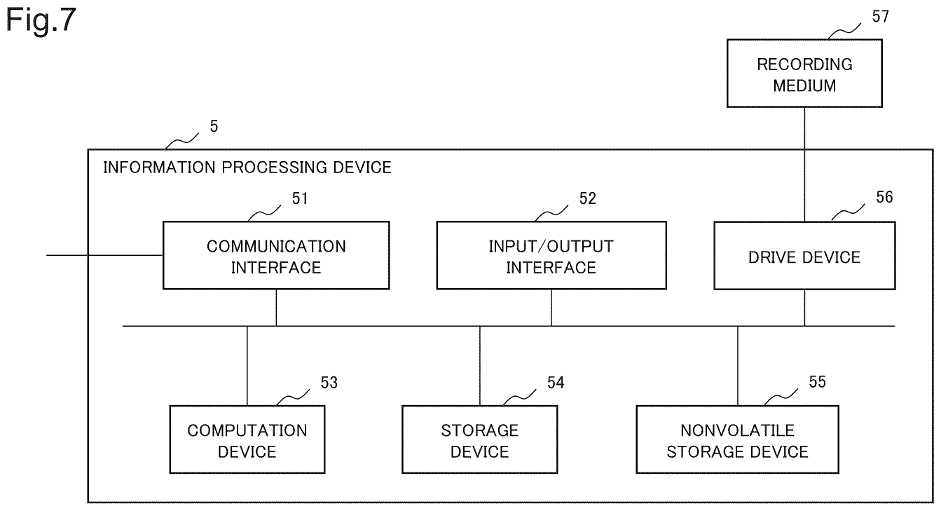

FIG. 7 is a diagram schematically illustrating a hardware configuration example of an information processing device capable of achieving the charging facility determination device according to each example embodiment of the present invention. An information processing device 5 includes a communication interface 51, an input/output interface 52, a computation device 53, a storage device 54, a nonvolatile storage device 55, and a drive device 56.

For example, the acquisition unit 11 of the charging facility determination device 1 of FIG. 1 can be achieved by the communication interface 51 and the computation device 53. The setting unit 12 and the determination unit 13 of the charging facility determination device 1 of FIG. 1 can be achieved by the computation device 53.

The communication interface 51 is a communication means for the charging facility determination device of each example embodiment to communicate with an external device in a wired or/and wireless manner. In a case where the charging facility determination device is achieved by using at least two information processing devices, the devices may be connected to communicate with each other via the communication interface 51.

The input/output interface 52 is a man-machine interface such as a keyboard as an example of an input device or a display as an output device.

The computation device 53 is achieved by a general-purpose central processing unit (CPU), an arithmetic processing device such as a microprocessor, or a plurality of electric circuits. For example, the computation device 53 can read various programs stored in the nonvolatile storage device 55 into the storage device 54 and execute processing according to the read program.

The storage device 54 is a memory device such as a random access memory (RAM) that can be referred to from the computation device 53 and stores programs, various pieces of data, and the like. The storage device 54 may be a volatile memory device.

The nonvolatile storage device 55 is a nonvolatile storage device such as a read only memory (ROM) or a flash memory, and can store various programs, data, and the like.

The drive device 56 is, for example, a device that processes reading and writing of data on a recording medium 57 described later.

The recording medium 57 is an any recording medium capable of recording data, for example, an optical disk, a magneto-optical disk, a semiconductor flash memory, or the like.

In each example embodiment of the present invention, for example, the information processing device 5 illustrated in FIG. 7 may constitute the charging facility determination device. Each example embodiment of the present invention may be achieved by supplying a program capable of achieving the functions described in each example embodiment to the charging facility determination device.

In this case, the example embodiment can be achieved by the computation device 53 executing the program supplied to the charging facility determination device. Not all but some of the functions of the charging facility determination device can be configured by the information processing device 5.

Further, the program may be recorded in the recording medium 57, and the charging facility determination device may be configured in such a way that the program is appropriately stored in the nonvolatile storage device 55 at a shipping stage, an operation stage, or the like of the charging facility determination device. In this case, as the program supply method, a method of installing the program in the charging facility determination device using an appropriate jig in a manufacturing stage before shipment, an operation stage, or the like may be used. As a method of supplying the program, a general procedure such as a method of downloading the program from the outside via a communication line such as the Internet may be used.

Some or all of the above example embodiments may be described as the following Supplementary Notes, but are not limited to the following.

### (Supplementary Note 1)

A charging facility determination device including
an acquisition means configured to acquire information capable of grasping a cruisable range of an unmanned flying object,
a setting means configured to set priority with which the unmanned flying object uses a charging facility according to a use, and
a determination means configured to determine a charging facility to be used by the unmanned flying object based on the cruisable range and the priority, the cruisable range being calculated by a calculation means based on the information.

### (Supplementary Note 2)

The charging facility determination device according to Supplementary Note 1, wherein
the setting means further sets the priority more highly in a case where a storage amount of the unmanned flying object indicated by the information acquired by the acquisition means is less than a predetermined value.

### (Supplementary Note 3)

The charging facility determination device according to Supplementary Note 1 or 2, wherein
the setting means sets the priority based on a date and time on which the unmanned flying object starts a work and a current date and time.

### (Supplementary Note 4)

The charging facility determination device according to any one of Supplementary Notes 1 to 3, wherein
the determination means determines a charging facility on a planned flight path of the unmanned flying object among available charging facilities as the charging facility to be used by the unmanned flying object.

### (Supplementary Note 5)

The charging facility determination device according to any one of Supplementary Notes 1 to 4, wherein
the setting means sets mutually different priorities for each of a plurality of the unmanned flying objects.

### (Supplementary Note 6)

A charging facility determination method including
acquiring information capable of grasping a cruisable range of an unmanned flying object,
setting priority with which the unmanned flying object uses a charging facility according to a use, and
determining a charging facility to be used by the unmanned flying object based on the cruisable range and the priority, the cruisable range being calculated based on the information.

### (Supplementary Note 7)

The charging facility determination method according to Supplementary Note 6, further comprising
setting the priority more highly in a case where a storage amount of the unmanned flying object indicated by the acquired information is less than a predetermined value.

### (Supplementary Note 8)

The charging facility determination method according to Supplementary Note 6 or 7, further comprising
setting the priority based on a date and time on which the unmanned flying object starts a work and a current date and time.

### (Supplementary Note 9)

The charging facility determination method according to any one of Supplementary Notes 6 to 8, further comprising
determining a charging facility on a planned flight path of the unmanned flying object among available charging facilities as the charging facility to be used by the unmanned flying object.

### (Supplementary Note 10)

The charging facility determination method according to any one of Supplementary Notes 6 to 9, further comprising
setting mutually different priorities for each of a plurality of the unmanned flying objects.

### (Supplementary Note 11)

A computer-readable recording medium recording a charging facility determination program for causing a computer to implement
an acquisition function of acquiring information capable of grasping a cruisable range of an unmanned flying object,
a setting function of setting priority with which the unmanned flying object uses a charging facility according to a use, and
a determination function of determining a charging facility to be used by the unmanned flying object based on the cruisable range and the priority, the cruisable range being calculated by a calculation means based on the information.

### (Supplementary Note 12)

The computer-readable recording medium recording the charging facility determination program according to Supplementary Note 11, wherein
the setting function further sets the priority more highly in a case where a storage amount of the unmanned flying object indicated by the information acquired by the acquisition function is less than a predetermined value.

### (Supplementary Note 13)

The computer-readable recording medium recording the charging facility determination program according to Supplementary Note 11 or 12, wherein
the setting function sets the priority based on a date and time on which the unmanned flying object starts a work and a current date and time.

### (Supplementary Note 14)

The computer-readable recording medium recording the charging facility determination program according to any one of Supplementary Notes 11 to 13, wherein
the determination function determines a charging facility on a planned flight path of the unmanned flying object among available charging facilities as the charging facility to be used by the unmanned flying object.

### (Supplementary Note 15)

The computer-readable recording medium recording the charging facility determination program according to any one of Supplementary Notes 11 to 14, wherein
the setting function sets mutually different priorities for each of a plurality of the unmanned flying objects.

Although the present invention is described above with reference to the example embodiments, the present invention is not limited to the above example embodiments. It will be understood by those of ordinary skill in the art that various changes in form and details may be made therein without departing from the spirit and scope of the present invention as defined by the claims.

### REFERENCE SIGNS LIST

1, 4 charging facility determination device
11, 41 acquisition unit
12, 42 setting unit
13, 43 determination unit
44 calculation unit
45 transmission unit
46 facility information storage unit
2 unmanned flying object
21 position measurement unit
22 storage amount calculation unit
23 transmission/reception unit
24 flight control unit
3 control device
31 transmission/reception unit
32 calculation unit
33 assessment unit
34 control information generation unit
35 flight plan storage unit
36 unmanned flying object information storage unit
5 information processing device
51 communication interface
52 input/output interface
53 computation device
54 storage device
55 nonvolatile storage device
56 drive device
57 recording medium

What is claimed is:

1. A charging facility determination device comprising:
at least one memory storing a computer program; and
at least one processor configured to execute the computer program to
acquire information capable of grasping a cruisable range of an unmanned flying object;
set priority with which the unmanned flying object uses a charging facility according to a use; and
determine a charging facility to be used by the unmanned flying object based on the cruisable range and the priority, the cruisable range being calculated by a calculator based on the information.

2. The charging facility determination device according to claim 1, wherein the processor is configured to execute the computer program to
set the priority more highly in a case where a storage amount of the unmanned flying object indicated by the acquired information is less than a predetermined value.

3. The charging facility determination device according to claim 1, wherein the processor is configured to execute the computer program to
set the priority based on a date and time on which the unmanned flying object starts a work and a current date and time.

4. The charging facility determination device according to claim 1, wherein the processor is configured to execute the computer program to
determine a charging facility on a planned flight path of the unmanned flying object among available charging facilities as the charging facility to be used by the unmanned flying object.

5. The charging facility determination device according to claim 1, wherein the processor is configured to execute the computer program to
set mutually different priorities for each of a plurality of the unmanned flying objects.

6. A charging facility determination method comprising:
acquiring information capable of grasping a cruisable range of an unmanned flying object;
setting priority with which the unmanned flying object uses a charging facility according to a use; and
determining a charging facility to be used by the unmanned flying object based on the cruisable range and the priority, the cruisable range being calculated based on the information.

7. The charging facility determination method according to claim 6, further comprising
setting the priority more highly in a case where a storage amount of the unmanned flying object indicated by the acquired information is less than a predetermined value.

8. The charging facility determination method according to claim 6, further comprising
setting the priority based on a date and time on which the unmanned flying object starts a work and a current date and time.

9. The charging facility determination method according to claim 6, further comprising
determining a charging facility on a planned flight path of the unmanned flying object among available charging facilities as the charging facility to be used by the unmanned flying object.

10. The charging facility determination method according to claim 6, further comprising
setting mutually different priorities for each of a plurality of the unmanned flying objects.

11. A non-transitory computer-readable recording medium recording a charging facility determination program for causing a computer to implement:
an acquisition function of acquiring information capable of grasping a cruisable range of an unmanned flying object;
a setting function of setting priority with which the unmanned flying object uses a charging facility according to a use; and
a determination function of determining a charging facility to be used by the unmanned flying object based on the cruisable range and the priority, the cruisable range being calculated by a calculator based on the information.

12. The computer-readable recording medium recording the charging facility determination program according to claim 11, wherein
the setting function further sets the priority more highly in a case where a storage amount of the unmanned flying object indicated by the information acquired by the acquisition function is less than a predetermined value.

13. The computer-readable recording medium recording the charging facility determination program according to claim 11, wherein
the setting function sets the priority based on a date and time on which the unmanned flying object starts a work and a current date and time.

14. The computer-readable recording medium recording the charging facility determination program according to claim 11, wherein
the determination function determines a charging facility on a planned flight path of the unmanned flying object among available charging facilities as the charging facility to be used by the unmanned flying object.

15. The computer-readable recording medium recording the charging facility determination program according to claim 11, wherein
the setting function sets mutually different priorities for each of a plurality of the unmanned flying objects.
